(19) United States
(12) Patent Application Publication
(10) Pub. No.: US 2008/0134569 A1
(43) Pub. Date: Jun. 12, 2008

(54) Bait Box

(76) Inventor: Stefan Endepols, Burscheid (DE)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/568,661

(22) PCT Filed: Apr. 22, 2005
(86) PCT No.: PCT/EP05/04341

§ 371 Date: Nov. 3, 2006

(30) Foreign Application Priority Data
May 5, 2004 (DE) 102004022105.7

(51) Int. Cl. A01M 1/20; A01M 25/00

(52) U.S. Cl. 43/131

(57) ABSTRACT

The present invention relates to a bait box made of plastic and comprising at least 1 lateral access adapted to the pest to be controlled and at least 1 fill port arranged at the top and adapted to the introduction of bait gel; a system for the use of gels in pest control, consisting of a bait box and an applicator; the use of the bait box and the system; a method of controlling pests.

The present invention relates to a bait box; to a system for the use of gels in pest control, consisting of bait box and applicator, and to the use of the bait box, or of the system, in pest control methods.

A variety of bait boxes for controlling pests are known from the prior art.

U.S. Pat. No. 3,750,326 discloses a bait box made of cardboard with lateral accesses and check ports arranged at the top.

U.S. Pat. No. 4,349,982 discloses a bait box made of plastic which has lateral accesses and a port arranged at the top which is suitable for refilling the box with flowable bait.

DE-A 195 01 892 discloses an open-top bait box without lateral accesses which is covered by an optionally transparent film arranged at a distance.

WO 02/102147 and U.S. Pat. No. 5,136,803 describe bait boxes in various designs whose lid can be opened for refilling the box with bait and for check purposes and which are additionally equipped with devices for holding block-shaped feed baits in place. The bait box described in WO 02/102147 has a window in the lid, through which the interior of the box can be viewed.

While the known bait boxes are suitable for the use of solid baits, they have a series of disadvantages: in order to fill bait boxes with solid baits, such as wax blocks or pastes, they must be opened. To prevent these compact baits from falling out or from being carried away by the rodents, they are placed into precisely matching compartments or grids (DE-A 39 05 489), threaded onto metal skewers (Protecta® Tamper Resistant Bait Box for rats) or held in place with wire (DE-U 299 01 578). Only flowable baits can be introduced without opening the bait box (U.S. Pat. No. 4,349,982).

A further disadvantage of the known bait boxes is that, as a result of their choice of material or construction, they are not, or not very well, suited for use with bait gels.

A further disadvantage of the known bait boxes is that simple and/or rapid refilling, in particular with bait gel or wax blocks, is not possible.

Pests are frequently controlled using feed baits. These baits can be displayed openly when it can be ruled out that they will be taken up by nontarget animals or influenced by abiotic factors such as climatic factors or cleaning procedures. To largely rule out these influences, bait boxes (also referred to as bait stations) are frequently used.

Bait boxes for controlling harmful insects consist, as a rule, of plastic and will already have been filled with bait by the manufacturer. The insects gain access to the bait by one or more accesses; if possible, they should be attracted by the bait. As a rule, these bait boxes are not refilled but disposed of after the control has been effected.

Bait boxes for harmful rodents, specifically for mice, are offered by some manufacturers as filled bait boxes. They contain one or more compact feed baits. Again, these bait boxes are not refilled, as a rule, but are disposed of after the control has been effected. As an alternative, bait boxes are used which are repeatedly refilled by the user during the control procedure. These baits can be used in a plurality of control activities, or else remain in place for continuous prophylaxis against infestation, where they are refilled at intervals of up to 3 months. Frequently, these stations are sealed in order to make access by those without authorization difficult (WO 02/102147) or they are designed in such a way that only the target animals reach the feed bait (DE-A 39 05 489).

Opening the bait boxes is an additional pass which requires additional work time, in particular when the bait boxes are either closed or difficult to open. This affects the costs, in particular in the professional pest control field, for example when several hundreds of stations are to be filled on premises where food is processed. It can therefore be said that filling bait boxes with compact baits is laborious and costly.

Bait boxes which can be filled externally without opening the bait box are known for flowable bait. Here, there is an increased risk that bait particles fall out of the stations or are carried away, which must be ruled out in particular in animal keeping and in the production of food- and feedstuffs. Flowable baits which are introduced externally into a bait box therefore pose a grave safety risk.

This is why the baits used in animal keeping and in the production of food- and feedstuffs are predominantly compact baits. While they can be fixed in place readily while in the unconsumed state, there is, again, the risk that parts of these baits fall out of the bait box or are carried away when they have been partly consumed by the rodents. Again, partly consumed compact baits pose the risk of contaminating the environment.

To solve this problem, it has proposed to use bait gels. Bait gels which are preferably used are those which still adhere to the bait box despite ageing, for example a water-based bait gel. This prevents bait particles falling out of the bait box or being carried away. Bait boxes which are optimized for the use of bait gels are not known.

It is an object of the present invention to do away with the abovementioned disadvantages by providing a novel bait box and a bait system.

The object is achieved by the features of claim 1 and of the further claims.

In the context of the present invention, the following terms will be used, inter alia:

Pests are harmful rodents, harmful insects or slugs and snails. Harmful rodents are, in particular, rats, mice and voles. Harmful insects are, in particular, crawling insects such as cockroaches, ants and termites.

Feed baits are compositions which are eaten by the pest in question and which contain at least one foodstuff and at least one poison which is active against the pest in question, at an effective dose. The poison used is a rodenticide or insecticide, depending on the target animal. A large number of different formulations for feed baits are known to the skilled worker and commercially available. Feed baits can be formulated as compact shaped articles (“wax-block type”), as a free-flowing or flowable bait or as a gel (“bait gel”).

Bait gels are feed baits with a pasty or gel-like consistency. The viscosity of the usable bait gels can be varied within wide limits and is generally at 5000-100000 mPas, preferably 8000-60000 mPas, especially preferably 10000-50000 mPas. The viscosity is measured using a rotary viscometer (from HAAKE) at a shear rate of D=10 [1/sec] or determined using a cone- and-plate measuring system (4°). The readings vary as the result of the heterogeneity of the bait gels. The viscosity can be adjusted by varying the type and proportion of the components, in particular the thickener and the bait material. Bait gels are known for example from WO 03/094612. The bait gel compositions disclosed therein are herewith expressly referred to. Fat or oil-based pasty formulations (“pasty bait gel”) are generally known to the skilled worker.

A bait box is a box for controlling pests, comprising at least one lateral access for the pest and space for a feed bait. Preferably, the bait box has two lateral accesses. The size of the lateral accesses is adapted to suit the pest to be controlled.

The bait boxes according to the invention have at least one fill port for filling the bait box with bait gel.

The bait box can have a transparent portion which is arranged in such as way that the bait gel inside is visible. In this way, the amount of bait gel present, and the necessity of refilling the box, can be estimated without having to open the box.

The transparent portion is preferably arranged on the upper side of the box.

The fill port can be located in the transparent portion.

Bait boxes are preferably made of plastic. Especially suitable plastics are those which can be processed by injection molding.

The size of the bait box is adapted to match the pest to be controlled. In general, the size of the bait box is such that at least one pest can move within the bait box and space for the feed bait is additionally available. The determination of the size is known to the skilled worker and can also be gathered from the above prior art or commercially available bait boxes.

The bottom of the bait box can be designed in such a way that the bait gel with which the box has been filled is kept within a delimited space. This is achieved by forming compartments or walls. This prevents the bait gel from expanding or from being spread by the pest.

In a further embodiment, the bait box can be designed in such a way that it cannot be opened. This furthermore improves the user safety of the bait box.

A fill port is a recess on the bait box which is suitable for filling the bait box with bait gel.

The size of the fill port is designed in such a way that nontarget animals and human fingers cannot reach the bait inside the bait box and that a sufficient cross section for filling the box with the bait gel is ensured. A circular fill port preferably has a diameter of 1-15 mm, especially preferably of 3-8 mm. The area of the fill port is 1-200 mm², preferably 10-100 mm², unless the fill port is circular.

The fill port is preferably located on the upper side of the bait box.

The fill port can be provided with a seal. The seal can be designed for example in the form of a flap, a slide, a bung, a screw-on or snap-on seal or a sealing lip.

One or more fill ports may be provided. The fill ports can be grouped in such a way that they can be filled simultaneously by one applicator. One or two fill ports are preferred, one fill port being especially preferred.

An applicator is a device for applying bait gel. Preferred applicators are those where the bait gel is applied by means of pressure. Such applicators are known to the skilled worker for the application of gels and pastes from their packaging, such as syringes, cartouches or tubes. Insecticidal gels, specifically for the control of cockroaches, are applied by professional pest controllers for example by means of what is known as the bait gun. Tradespeople and do-it-yourself enthusiasts are familiar with applicators by means of which building materials such as, for example, silicone or acrylic can be applied from cartouches with a content of approximately 300 ml. Preferred containers for rodenticidal gels are cartouches which are used together with the abovementioned, or other suitable, applicators for squeezing out the gel.

In a preferred embodiment, the applicator, or the gel container, has an elongated outlet, for example a tip, a tube or pipe, whose cross section is designed in such a way that it can be pushed through the fill port of the bait box.

In one embodiment, the outlet of the applicator or of the gel container and the fill port of the bait box have a positive fit. For example, the outlet can be round, star-shaped or triangular in shape.

In a further embodiment, the outlet is designed in such a way that it can only be inserted into the fill port of the bait box up to a certain depth (“insertion depth”). This can be achieved for example by a suitable groove at the outlet, by the total length of the outlet or by a conical design of the outlet.

The insertion depth can be such that the outlet does not reach the bottom of the bait box but only just above. Depending on the consistency of the gel and on the diameter of the outlet, this distance is adjusted in such a way that, upon squeezing out, the gel is squeezed onto the bottom with enough force to adhere thereto. In this position, an adequate amount of the gel is squeezed into the bait box. Possible distances are, for example, 1-20 mm, preferably 3-10 mm.

The present invention furthermore relates to a system for controlling pests, consisting of a bait box as described above and an adapted applicator or gel container, as described above. The adaptation is effected by matching the outlet of the applicator and the fill port of the bait box to one another. The adaptation can furthermore be accomplished by matching the size of the bait box, the dosage of the applicator and the choice of the bait gel to the pest to be controlled and the bait boxes to be filled. Such adaptations can be carried out by the skilled worker himself with the aid of simple calculations and routine experiments.

The present invention furthermore relates to a method of controlling pests using bait boxes and bait gels, characterized in that bait gels are applied into the bait box through a fill port, with the aid of an applicator.

The present invention furthermore relates to the use of the bait boxes according to the invention in a method as described in EP-A 1 389 039; this publication is expressly referred to herewith.

1. A bait box made of plastic, comprising at least 1 lateral access adapted to a pest to be controlled and at least 1 fill port adapted to the introduction of bait gel.

2. The bait box as claimed in claim 1, comprising, a top and wherein said at least 1 fill port is arranged at said top.

3. The bait box as claimed in claim 2, comprising 2 lateral accesses adapted to the pest to be controlled, and 1 fill port.

4. The bait box as claimed in claim 1, wherein the bait box comprises a transparent upper part.

5. The bait box as claimed in claim 2, wherein said top is sealable.

6. A system for controlling pests, consisting of a bait box as claimed in claim 1 and an applicator or a gel container, characterized in that the applicator or the gel container comprising an outlet and the fill port of the bait box and the outlet of the applicator or the gel container are matched.

7. A method of use of the bait boxes as claimed in claim 1 for controlling pests, comprising placing the bait boxes at suitable locations.

8. (canceled)

9. A method of controlling pests comprising:
placing one or more of the bait boxes as claimed in claim 1 at suitable locations;
applying bait gels into one or more of the bait boxes through a fill port, with the aid of an applicator; and
reapplying the bait gels into one or more of the bait boxes, wherein the bait gels are consumed, until the control process has ended.
